(19) United States
(12) Patent Application Publication
(10) Pub. No.: US 2012/0317044 A1
(43) Pub. Date: Dec. 13, 2012

(54) METHOD, SYSTEM, AND SOFTWARE FOR CREATING A COMPETITIVE MARKETPLACE FOR CHARITIES AND PATRONS IN AN ONLINE SOCIAL NETWORKING ENVIRONMENT

(76) Inventor: Michael Massarik, Los Angeles, CA (US)

(21) Appl. No.: 13/492,755

(22) Filed: Jun. 8, 2012

Related U.S. Application Data
(60) Provisional application No. 61/494,986, filed on Jun. 9, 2011.

(51) Int. Cl. G06Q 99/00

(52) U.S. Cl. 705/319; 705/329

(57) ABSTRACT

A method, system, and software for creating a competitive marketplace for charities and patrons in an online social networking environment.

### CROSS-REFERENCE TO RELATED APPLICATIONS

This non-provisional utility patent application claims the benefit Jun. 9, 2011 priority date of provisional patent application 61/494,986, filed on Jun. 9, 2011, under 35 USC §119(e).

### FIELD OF THE INVENTION

This invention relates to e-philanthropy, specifically to online marketplaces, exchanges, and transactions in a social networking environment. In particular it describes creation of a central clearinghouse or exchange where charities can register and market themselves to potential patrons or donors, who can search, find and contribute to charities and nonprofit organizations within an online social network.

### BACKGROUND OF THE INVENTION

The main challenge for charitable organizations and causes is fund-raising. It is expensive and requires substantial marketing effort. A potential patron to a charitable cause or organization also faces several challenges: finding suitable beneficiaries; verifying the legitimacy of them; and transmitting funds to selected beneficiaries.

Currently there exists no centralized exchange which effectively connects charities with potential patrons, which provides standardized information about the caliber and authenticity of the charities, which allows charities to compete for contributions, and which provides patrons with a simple way to construct and contribute to portfolios of charities. This problem of connecting supply and demand is a familiar one dating back to the beginnings of human trade and commerce. A relevant example is the development of securities trading as it evolved from unregulated small transactions to centralized trading on competitive open stock exchanges that only list companies which meet certain standards and publicly disclose their records. A similar evolution has occurred in many industries, and much of the rapid expansion of the internet has been driven by the creation of virtual marketplaces which connect both sides of a potential trade. The problem is consistently, safely and effectively connecting two sides of a potential deal, providing necessary information and disclosure, and providing a list of competitive products, whether it is about selling one's used goods on eBay, finding a potential mate on Match.com, or trading stocks on E*TRADE.

Today when a patron researches a charity on the internet (or by other means), the patron typically visits many different websites, collecting piecemeal information which may not provide answers sufficient to make informed contribution decisions.

What is needed is a technology which can bring patrons and charitable entities together in an orderly and effective way. Such a technology would help simplify and optimize transactions, organize charitable contributions, provide greater visibility, potentially increase charitable contributions, and bring needed turn-key solutions to charities who presently appear to underestimate the impact technology could have on their fund raising capabilities.

Accordingly, the present invention described herein addresses these obstacles by providing an e-philanthropy clearinghouse for charitable contributions. This exchange lists registered charities and serves as a supermarket for potential patrons who can use it to shop for charitable organizations or causes to support. It provides patrons with a searchable database of donation targets, standardized information about the targets, authentication of targets, and a mechanism for transferring funds to selected targets. It also helps patrons log their activity and keep track of their charitable contributions for tax and accounting purposes, and further provides charities and patrons with the opportunity to create social networks for establishing local or global support for specific causes and charitable organizations.

### BRIEF SUMMARY OF THE INVENTION

The preferred embodiment of the present invention is a method, system, and means for creating a central exchange market place for charities and charitable contributions in an online social network environment.

A fundamental feature of this invention is that charities will compete in a central market place for contributions. Charities with low expense ratios, which can be thought of as a metric which is the quotient of total contributions received by said charity divided by the total of all of said charity's expenses, shows that the charity is working more effectively by a lower overhead and a greater giving to their cause or mission statement. A charity with lower expenses will be more competitive than a charity with higher expenses and which gives less to their cause or mission statement. Another important metric which shows the effectiveness of how a charity does business is the quotient of total contributions received by said charity divided by the total funds expended by said charity on goods and services directly related to the charity's cause/mission statement. The prior metric shows that a charity is more effective in dispersing funds for good and services to their cause/mission statement then a charity which is keeping more of their contribution and dispersing less funds to their cause/mission statement. The invention thus provides a way to compare charities directly through standardized information so there is transparency and information symmetry. A potential patron can come to the online marketplace and easily discover standardized information, somewhat analogous to standard stock metrics, needed to make educated decisions. This information comprises its expense ratio, its amount it gives to its cause/mission statement ratio, how it allocates contributions, the name of its accounting firm, its priorities, mission statement, videos and information about the charity, how it gives, a personal message to its patrons, current news about the charity, its country of origin, legal status, and general verification that the information is correct with regard to public record or other verification processes.

The present invention provides such a technology by creating a central exchange market place for charities and potential patrons in an online social networking environment. In some respects it can be likened to a combination of an online securities trading engine such as E*TRADE—where the investments are charitable contributions in this case—and a social networking engine such as Facebook. This combination brings the ability to execute rapid online transactions with pre-qualified entities together with the dissemination power of online social networking.

The invention will benefit charities in a number of ways: provide visibility; let them compete for contributions in a competitive marketplace; make it easier to accept contributions through credit card, Pay-Pal, electronic check, texting, etc; enable rapid and wide communication with the charity's patron bases; reduce the cost of fundraising events; increase their potential patron base; and provide a fast way to receive contributions for urgent events such as natural disasters, etc. It will also benefit patrons by providing an easily accessible central location to search legitimate charities; instant information about how contributions are spent; easy ways to provide payment; participation in disaster relief; and quick access to consolidated contribution statements for tax purposes.

The invention also allows for sponsoring entities to set up a portfolio of charities with a designation of how each contribution gets divided between portfolio charities. Such a portfolio would thus act somewhat like a stock mutual fund, and a patron could thus contribute to a general cause like cancer and cover several charities rather than contributing to individual charities focused on cancer. The sponsoring entity could participate with matching funds or co-contributions to the portfolio charities, and it might also provide coupons for goods and services to the patrons to incent giving.

### BRIEF DESCRIPTION OF THE DRAWINGS

FIG. 1 shows the home page of the preferred embodiment of the present invention.

FIG. 2 illustrates how a particular charity is presented in the preferred embodiment.

FIG. 3 shows the preferred embodiment of how a user would make a charitable contribution.

FIG. 4 is an example of a contribution page for emergency relief according to the preferred embodiment of the present invention.

FIG. 5 illustrates a patron sign-up page

FIG. 6 shows a charity sign-up page

FIG. 7 is an example of a social networking page according to the preferred embodiment of the present invention.

FIG. 8 shows a page used by a charity to upload information to its unique standardized charity page

FIG. 9 illustrates a payment instructions page

FIG. 10 shows a payment information page.

### DETAILED DESCRIPTION OF THE INVENTION

The following description illustrates the invention by way of example, not by way of limitation of the principles of the invention. This description will enable one skilled in the art to make and use the invention, and describes several embodiments, adaptations, variations, alternatives and uses of the invention, including what we presently believe is the best mode of carrying out the invention.

Prior art. An example of relevant prior art is U.S. patent application Ser. No. 12/649,346 (Publication Number U.S. 2011/0071907 A1), which teaches a means and method of facilitating charitable contributions through an interactive social media networking community website with advertising, contribution, and distribution functions. This invention is designed to maximize charitable contributions and allows for a tailored distribution scheme that supposedly more effectively raises and distributes charitable contributions. This disclosure differs from the current invention in that it does not provide a competitive marketplace with standardized information where charities compete for contributions and where potential patrons can access centrally organized data bases of charities with standardized financial metrics which make it possible to evaluate the relative quality of charities. U.S. patent application Ser. No. 12/649,346 (Publication Number U.S. 2011/0071907 A1) also differs from the present invention in that one of its principal objectives is to engage celebrities, athletes, politicians and other publicity-seeking individuals to provide free advertising for charitable organizations.

Other examples of prior art might be Charity Navigator (www.charitynavigator.org), Just Give (www.justgive.org), and Network for Good (www.networkforgood.org). These sites however do not provide a competitive and standardized marketplace for charitable transactions within a social network, they do not relate charities to financial type ratio metrics similar to Price to Earnings (P/E) ratio etc, they do not offer standardized charity pages to promote an ease of comparison for patrons to understand a charity's specifics and easily differentiate one charity form another. They further do not provide a central clearinghouse for disaster relief, such as giving patrons current news from an emergency, while simultaneously giving the patron an immediate way to contribute funds to a number of charities simultaneously to address the needs of that emergency on a web page or with a tablet or smart phone application. The prior art also does not allow for charities to interact with its own and potential new patron bases, whereas the present invention builds an interactive Facebook-type community for charitable activities. The prior art does not allow a charity to invite or solicit patrons who are members of the site, but not a current contributor to their charity.

Preferred embodiment. In the context of its basic method, the present invention's most basic embodiment is software programs, applications, and engines, especially in connection with the interne, providing user interfaces accessible by computer, tablet, or smart phone. A particular embodiment is a web application using a web browser as a (thin) client. This embodiment allows for centralized orderly charitable contributions and potentially makes e-philanthropy more easily accessible to the world's two billion interne users.

In the preferred embodiment, a charity registers itself on the website by providing qualifying information, while a patron signs up for an account. Once the patron account is established, the patron can then search, select, and contribute to a charity. Charities can message, <<friend request>>, or invite the patron to join its patron base. The invention can in some sense be thought of as a ‘Facebook for charities and patrons’, allowing charities to communicate with and raise funds from their patron base, and potentially other patron bases in our social network.

It is important to understand that charity pages of the exchange described herein are always open, searchable, and directly accessible by all internet public, and are not accessible only through the page hierarchy of the basic website. For example, if one were to Google the Red Cross, which would likely be a member of the exchange, the Red Cross would come up as a search result alongside the name of the exchange, making it likely that the patron will make a contribution through the central clearinghouse service of the exchange.

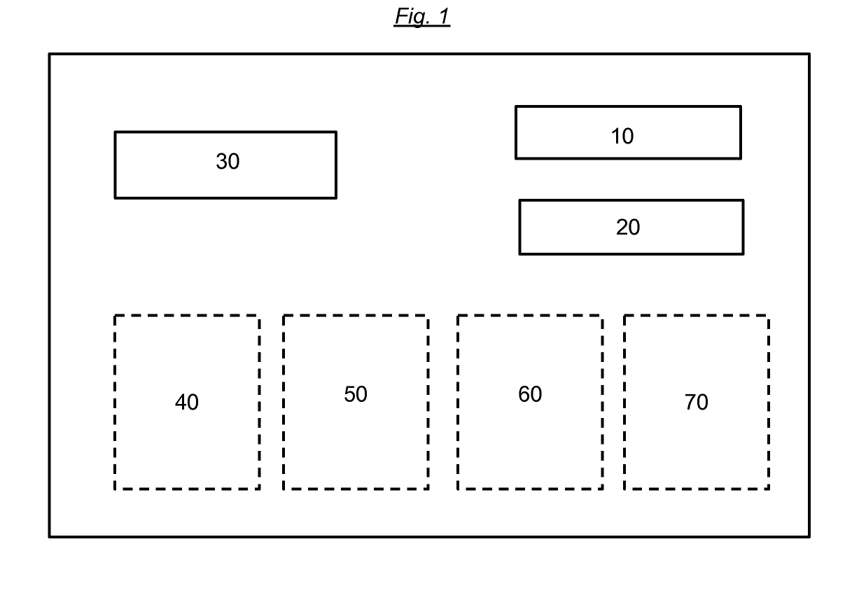

Referring now to the drawings, in which like reference numbers represent similar or identical structures throughout, FIG. 1 shows the basic graphical user interface for the homepage of the internet site. This homepage can be accessed in various ways: directly entering the domain name into a browser window; going through a search engine such as Google or Yahoo; by way of an affiliate program link to the homepage from a banner on a different internet site. On the homepage traditional login boxes for username 10 and password 20 allow an account holder to log in to her account (stored on a central server, not shown). A charity search is driven from a search dialogue box 30 wherein the potential patron can enter a search term, which could be either the name of a specific charity or general phrase such as <<cancer>>, <<environment>>, or other charity-related terms. Descriptions of how to set up an account 40, find a charity 50, chose a direct charity 60, and how to chose and to contribute to a sponsored portfolio 70 of charities like a stock mutual fund, which allows a patron to contribute to a general cause like cancer that covers several charities, are also present on the page.

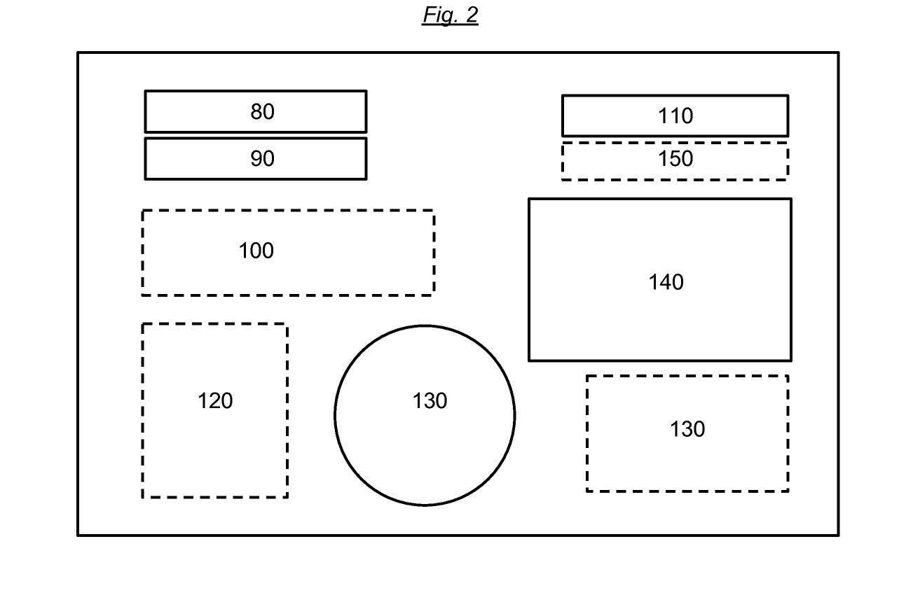

Once a potential patron has entered a search, a different webpage will appear, as shown in FIG. 2. This page provides the name(s) 80 of the found charity, and its basic focus 90 and mission 100. It also displays a code 110 for that specific charity, similar to a stock ticker symbol. The page also lists information about how the charity uses its donations 120 and provides a budgeting and accounting breakdown 130, which includes displaying charity specific metrics, allocations to administration, advertising, fund raising, operations, etc. The legal status of the charity, its country of origin, and the name of its accountant are also displayed. This serves an important vetting function and tells the user about the caliber and legitimacy of the charity. Charities that meet exceptionally high standards qualify for special certification status, which is indicated graphically to the user (not shown). The page also provides access to further information about the charity such as YouTube video clips 140, etc. The information described above help potential patrons make informed donation decisions, and allows them to select charities with a low expense ratio, for example. A clickable link 150 lets the user add the charity to her portfolio of charities. The link 150 will either bring up the user's updated portfolio, or direct the user to login or a sign-up page if the user is not currently a member of this social network. Once the charity has been added to the portfolio, the user can make a donation to it.

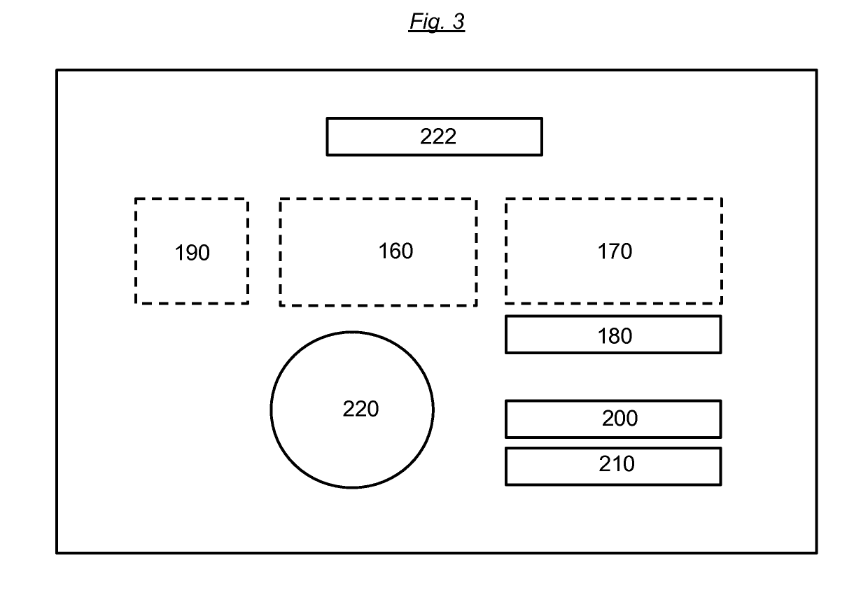

The portfolio page, as shown in FIG. 3, presents a portfolio list 160 of the charities to which a particular patron typically donates. Dialogue boxes 170 let the patron make new donations in desired amounts, which are automatically summed to a total 180. The portfolio page also displays the patron's account information 190, the patron's total donations for the current year 200, and her total cumulative contributions 210. A pie chart 220, or similar graphical representation, of how donations have been allocated across charities in the portfolio, is also displayed. There is also a way to add a new charity 222 to the portfolio 160. There is also a message link (not labeled) on the page, allowing for social networking functions and communication links such as intra-site email.

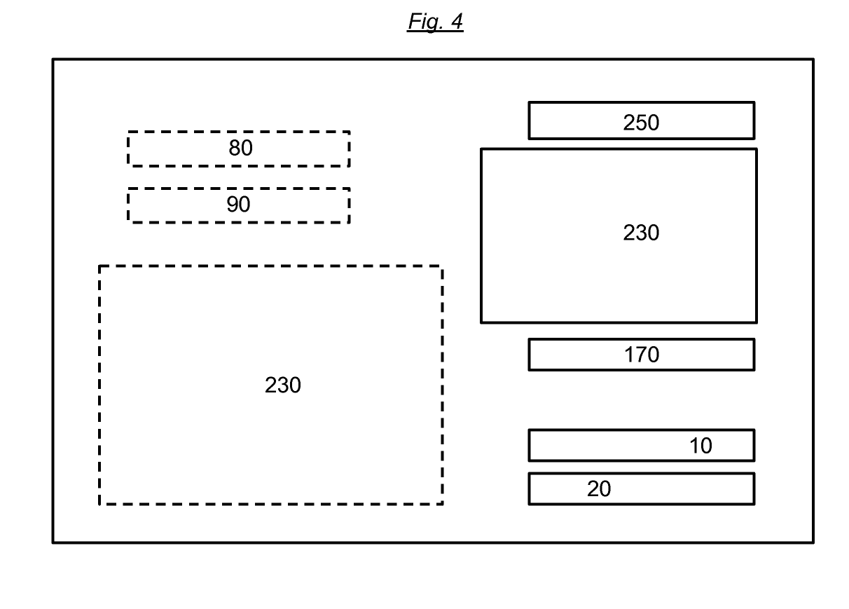

A further feature of the preferred embodiment is a page dedicated to contributions and donations intended for emergency causes, such as disaster relief, etc, as seen in FIG. 4. Potential patrons can access this page through any of the other pages on the website by way of icons or banners present on each one of these pages, or directly through a search engine such as Google or Yahoo. The page displays the Emergency's name 80 (the names of a charity or several charities may also be displayed, in which case a determination will be made about the relative contributions to each charity), its focus 90, and a live news feed 230 about the emergency, which could include text and video feeds, Twitter links and feeds, blog links, YouTube video messages, etc. A donation box 170 allows the user to enter a desired contribution amount, and a running total 250 of the amount raised from all patrons is displayed. Patrons can thus contribute to a particular emergency through several charities focused on that emergency, with real time news and information regarding that emergency.

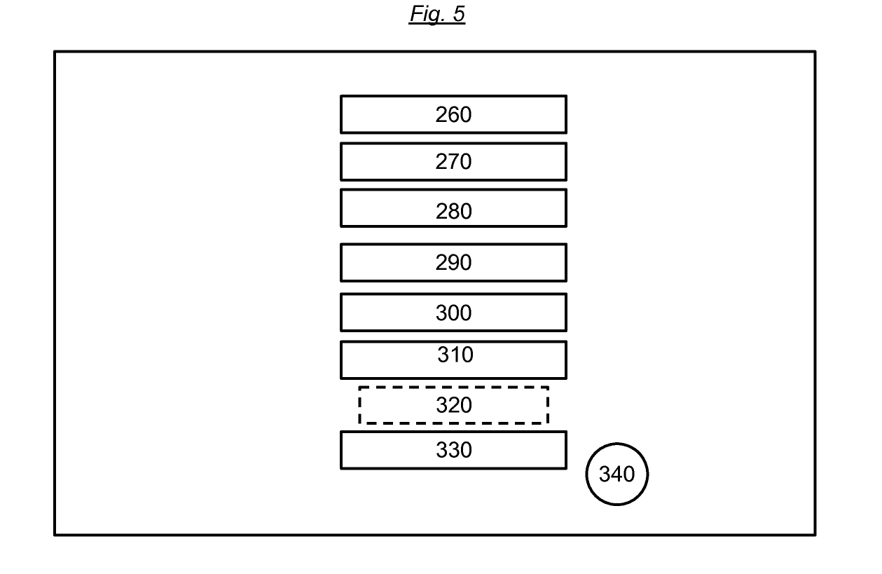

A specific patron sign-up page, as shown in FIG. 5, allows a patron to enter last name, first name, username, password, password confirmation into boxes 260, 270, 280, 290, 300, 310. Also shown is a CAPTCHA code 320, code entry box 330, and a submit button 340.

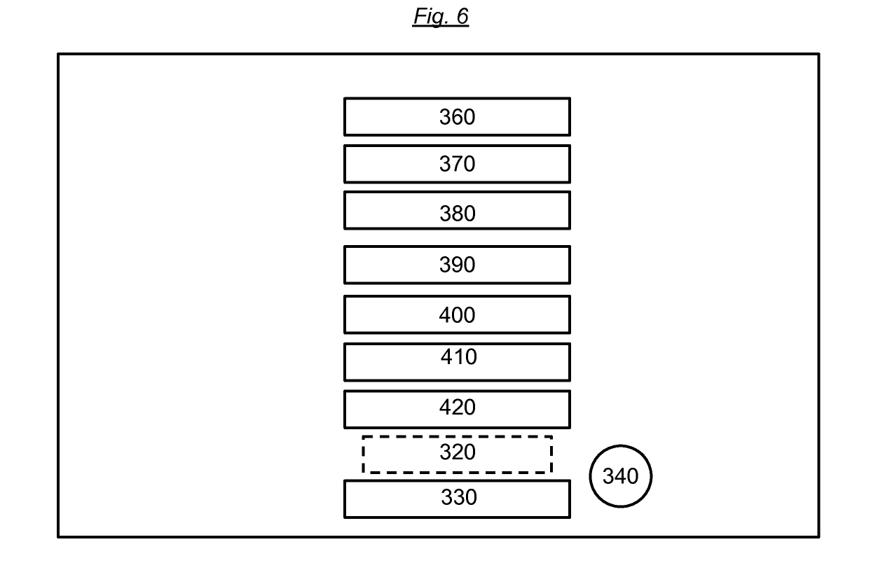

Similarly, a charity sign-up page (FIG. 6) lets charities enter name, identifier such as 501(c) non-profit organization number, contact info, username, password, password confirmation, and country into boxes 360, 370, 380, 390, 400, 410, 420. A CAPTCHA code 320, code entry box 330, and a submit button 340 are also included.

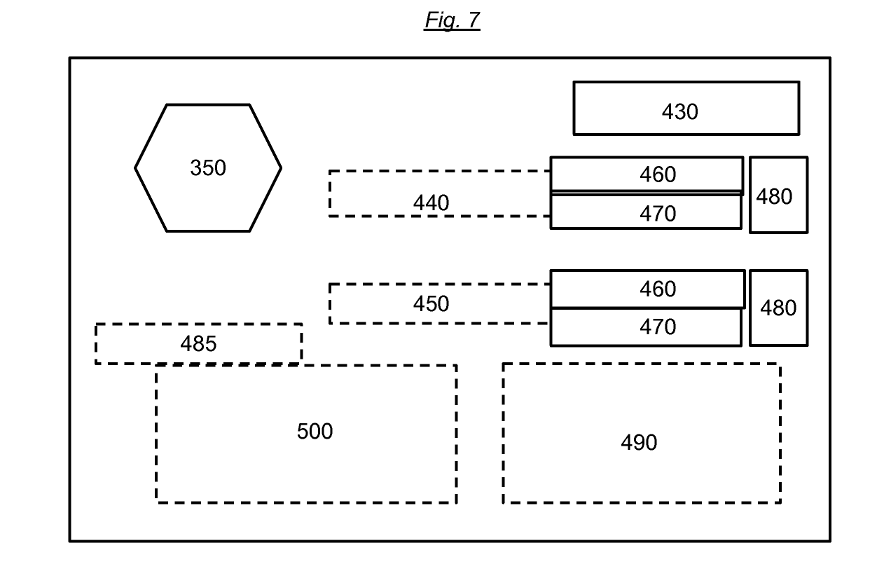

FIG. 7 shows a social networking page which provides a search box 430 and lists certain relevant charities 440, 450 and topic lines 460, 480. Next to each charity is a box 460 allowing a user to “Read an existing topic”, a box 470 to “Start a new topic” or start a new online community, and a drop-down menu 480 showing top topics. Once a topic 460 or 480 is chosen (clicked on) or a new topic or online community is added 470 the topic or online community name will appear in box 485. There is also a box to enter text 490 and a box 500 which displays an ongoing discussion.

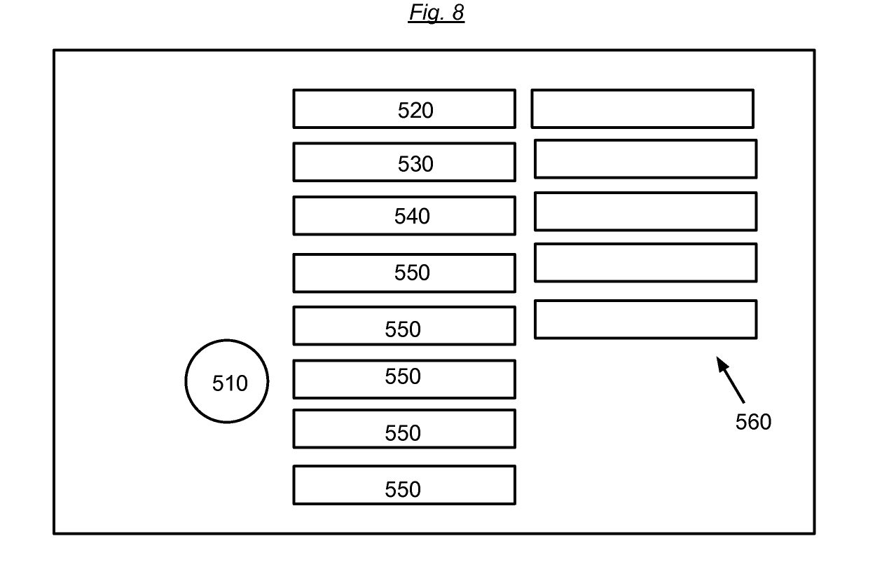

The charity personalized page (FIG. 8) allows a charity to upload information and video it would like displayed on its unique standardized charity page. It includes a mission statement 520, a YouTube clip and recorded events video 530, charity focus 540, and various information about the charity and fund allocations, contribution allocation, expenses, accounting firm information, with corresponding boxes 550 (with an upload button 510). There is also a list 560 where a charity enters the top ways in which contributed funds are used by the organization. A button 510 allows the charity to submit the information to the website operator for display on the charity's unique standardized charity page.

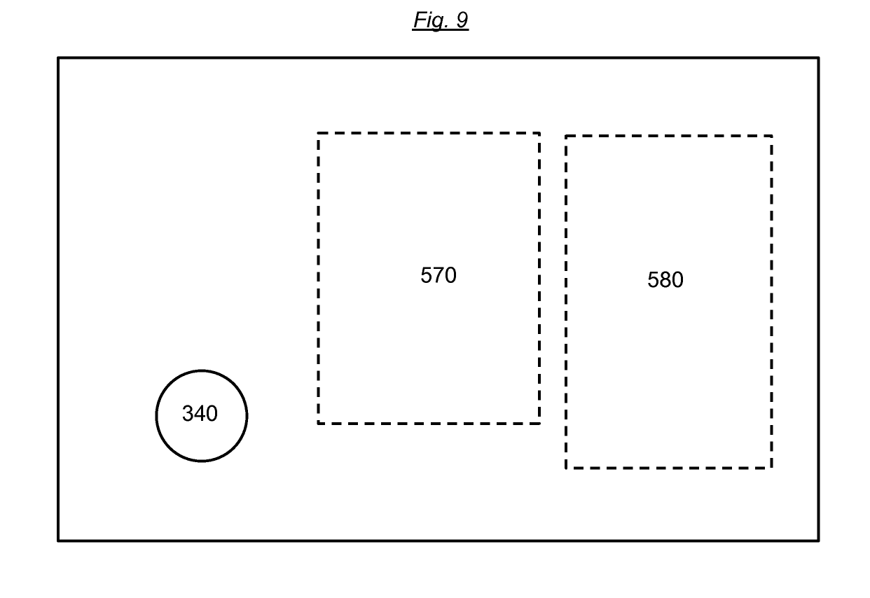

A charity receivables instruction page, as illustrated in FIG. 9, has a field 570 which allows a charity to enter electronic wiring information such as account name, routing number, account number, bank name, bank address, and bank phone number, and another field 580 which allows a charity to enter physical delivery check payment information such as name, contact, and address and submit said receivables information to the web site with a submit button 340.

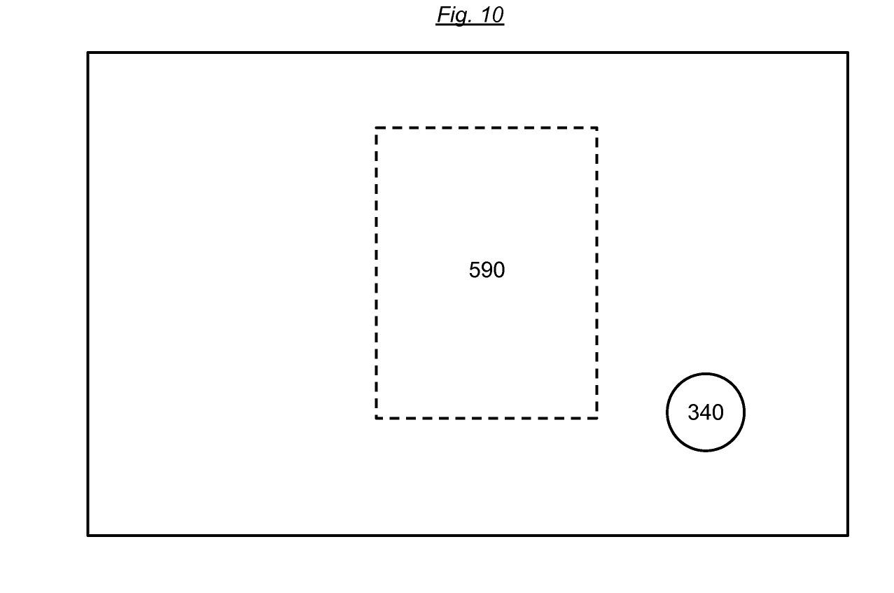

A payment information page, FIG. 10, allows a patron or charity to enter standard credit card information such as card type, account number, cardholder name, expiration date, CSC number, etc. or other forms of payment information such as electronic check or Paypal information into field 590 and submit said payment information to the web site with a submit button 340.

The preferred embodiment of the present invention also includes a mechanism for contributing to multiple charities in single action by making a contribution to a predetermined portfolio. Such a predetermined portfolio is a preselected basket of charities, much like a stock mutual fund, within a certain sector, such as <<peace>>, <<poverty>>, <<children>>, or as designated by a sponsor such as a corporation who has a list of preferred charities they give to on an ongoing basis, etc. In the same way as the purchaser of a mutual fund achieves investment diversification through the single purchase of a fund which has been assembled by professionals, a potential patron can spread the benefit of their contribution across multiple charities while avoiding the laborious process of finding and making contributions to each individual charity.

The present invention also allows charities to sign up for priority services which would give them preferential advertising positioning through sponsored links, as is common practice with search engines such as Google. Charities can also sign up for programs designed for emergencies such as disaster relief, etc. Further, a charity can sign up for exclusive status which affords them the advantage of marketing directly to registered patrons not currently in their patron base for that particular charity. Another feature of such exclusive status is a specific identifier, such as a different ticker symbol preferred by the charity, making it easier for high profile charities to identify themselves to patrons. In general identifiers will be available on a first come first serve basis.

The present invention further lets a patron or a charity start an online community, which is somewhat similar to creating Facebook groups. A patron or charity can set up a unique page where other like-minded patrons and charities can join together to discuss and support a cause.

The present invention also features invitations to join a charity. Registered charities have the opportunity to issue invitations to potential patrons with a certain patron profile and contribution history. A charity has access to patron lists through the online marketplace. A charity thus invites the patron by giving the patron a link to their charity page, and if the patron is interested, the invitation is accepted by clicking on the link on the charity's page to add the charity to the patron's portfolio, much like friend invitations are accepted on Facebook.

Invitations to specific events are also within the scope of current invention. Charities can invite their patron base to specific events or fundraisers through direct invitations electronically sent to the patron and through the social network. For terrestrial events, patrons can receive free tickets or purchase tickets, transportation, and living accommodations through the marketplace, or make contributions online in case the patron cannot physically attend the event. The present invention also lets charities provide live video, and news feeds from such events, along with real time fundraising updates.

With the present invention, charities are further able to host auctions for fund-raising purposes. In an auction, a charity lists auction items, which could be goods or services, and electively has the option to sets a reserve price and termination date, similar to online auctions conducted on sites such as eBay, or in real time like Sotheby's Auction House.

A significant advantage of the marketplace model of the present invention is that transaction fees can be charged for the clearing of contributions, very much like transaction fees are charged for buying and selling stock on an exchange. This opens up a unique avenue to funding which obviates needs for membership fees from patrons, basic services fees from charities, and banner advertising fees.

Accordingly, the present invention provides a method, system, and means for creating a competitive marketplace for charities and patrons in an online social networking environment.

The present invention has been described above in terms of a presently preferred embodiment so that an understanding of the present invention can be conveyed. However, many alternative ways of constructing the website, software engine, and interne systems are possible without departing from the principle of the invention. The scope of the present invention should therefore not be limited by the embodiments illustrated, but rather it should be understood that the present invention has wide applicability with respect to its stated objectives. All modifications, variations, or equivalent elements and implementations should therefore be considered within the scope of the invention.

1. A website accessible by a computer device such as a desktop, laptop, tablet, or smartphone for connecting patrons and charities, for providing standardized information about charities, and for providing standardized and orderly interactions between patrons and charities, comprising:
a patron sign-up page allowing a prospective patron to register with said website comprising a region for entering a username, and a region for entering a password;
a charity sign-up page allowing a charity to register with said website comprising a region for entering a name, a region for entering a username, and a region for entering a password;
a patron portfolio page for building a portfolio of charities comprising a region for entering character strings for conducting searches, a region for adding a charity to a portfolio, a region for displaying portfolio charities, a region next to a portfolio charity for entering a contribution amount, and a region which allows a patron to simultaneously remit contributions to portfolio charities with a single click; and
a standardized charity page which can be publically searched and found through a search engine such as Google comprising standardized information for direct and easy comparison between different charities, including a region showing the name of a charity, a region showing said charity's identifier, such as a unique ticker symbol, a region showing a standardized metric which is the quotient of total contributions received by said charity divided by the total funds expended by said charity on goods and services directly related to its focus, and a region wherein clicking in said region will reroute a patron directly to said patron's portfolio page where said charity will automatically have been added to said patron's portfolio.

2. The website of claim 1 wherein said portfolio page further displays a patron's name and unique identifier, displays the total of scheduled contributions to said portfolio charities, displays total year to date contributions made by said patron, displays the total of all contributions said patron has ever made, and displays a breakdown of contributions made to each charity.

3. The website of claim 1 wherein said standardized charity page is of one of many charity pages unique to each registered charity, and wherein the information on said page is stored in a database of standardized information about charities.

4. The website of claim 1 wherein profile information about said patrons is stored in a database which the operator of said website controls and which said operator can use to connect charities with patrons of certain profile information.

5. The website of claim 1 wherein said standardized charity page further comprises a region showing a charity's main focus, a region showing a charity's mission statement, a region showing a playable video item about said charity, primary ways in which contributions are used, a region showing a breakdown of how contributions are used, a region showing a charity's legal status, a region showing a charity's country of origin, a region showing a charity's accounting firm, a region showing a metric which is the quotient of total contributions received by said charity divided by the total of all charity expenses, and a region allowing a user to select from a list of videos.

6. The website of claim 1 wherein said standardized charity page further comprises a metric which is the quotient of total contributions received by said charity divided by the combined total of said charity's advertising, fundraising, and administration expenses; a metric which is the quotient of total contributions received by said charity divided by said charity's advertising expenses; a metric which is the quotient of total contributions received by said charity divided by the total of said charity's fundraising expenses; a metric which is the quotient of total contributions received by said charity divided by the total of said charity's administration expenses; a metric which is the quotient of total contributions received by said charity divided by the combined total of said charity's advertising and fundraising expenses; a metric which is the quotient of total contributions received by said charity divided by the combined total of said charity's advertising and administration expenses; a metric which is the quotient of total contributions received by said charity divided by the combined total said charity's on fundraising and administration expenses; a metric which is the quotient of a combined total of a charity's liquid and non-liquid assets divided by all contributions; a metric which is the quotient of the combined total of a charity's liquid assets, non-liquid assets and goodwill, divided by all contributions; a metric which is the quotient of all non-liquid assets divided by all contributions;
and a metric which is the quotient of all liquid assets divided by all contributions.

7. The website of claim 1 further comprising a homepage with links for navigating said site.

8. The website of claim 1 further comprising an emergency charity page which can be publically searched and found through a search engine such as Google and which allows contributions to time-sensitive causes, comprising a region displaying the cause, a region displaying a dynamic total contributions to a cause, a region for entering contribution amount, a region for executing said contribution, and a region displaying current news about a cause.

9. The website of claim 1 further comprising an emergency charity page which can be publically searched and found through a search engine such as Google and which allows contributions to time-sensitive causes comprising a region displaying the cause, a region displaying the focus of a cause, a region displaying total contributions to a cause so far, a region for entering contribution amount, a region for executing said contribution, a region displaying a playable video about a cause, a region displaying current news about a cause, a region displaying a description of said cause, a region which allows a patron to select playable videos from a list, and regions for entering username and password for registered user to log in to said website.

10. The website of claim 1 further comprising a social networking community private page wherein registered patrons can interact and share information, comprising a region for entering search topics, a region displaying ongoing discussions, a region for entering text to participate in a discussion, and a region for starting a discussion on a topic.

11. The website of claim 1 further comprising a social networking community public page which can be publically searched and located through a search engine such as Google, wherein a non-registered user can register to join a discussion.

12. The website of claim 1 further comprising a charity information entry page wherein a charity can enter and upload their information to be displayed on said standardized charity page.

13. The website of claim 1 further comprising a function allowing a charity to initiate a live event hosted on said charity's charity page, wherein said function comprises sending invitations to registered patrons electronically.

14. The website of claim 1 further comprising a function allowing a charity to initiate a live event hosted on said charity's charity page, wherein said function comprises sending invitations to registered portfolio patrons, providing real time online streaming of the event, and offering transportation and lodging associated with said event.

15. The website of claim 1 further comprising an auction function which allows a charity to host a fundraising auction on said charity's charity page, wherein said auction function sends auction notifications to registered patrons and comprises standard online auction features.

16. The website of claim 1 further comprising a patron invitation function which a charity can use to initiate a process of sending invitations to registered patrons of a certain profile, wherein said invitations include a link to said charity's charity page.

17. The website of claim 1 further comprising a payment information page wherein a user can input and save payment details such as credit card and banking information and any details necessary for making online payments.

18. The website of claim 1 further comprising a charity receivables page wherein a charity can enter bank wire information, address, and any details necessary for receiving contributions.

19. The website of claim 1 further comprising a mutual giving page wherein a sponsor can set up a portfolio of charities along with a designation of how donations are to be allocated, and invite patrons to make contributions which will trigger said sponsor to make co-contributions.

20. The website of claim 1 further comprising a mutual giving page wherein a sponsor can set up a portfolio of charities along with a designation of how donations are to be allocated, and invite patrons to make contributions in exchange for sponsor provided coupons for goods and services.

21. The website of claim 1 further comprising a function for initiating formation of a social network consisting of select registered patrons and charities of particular profiles and interests.

22. The website of claim 1 further comprising a function wherein a registered charity or patron can invite a registered charity or patron to join a social network.

23. The website of claim 1 further comprising a function allowing a registered charity to initiate a charity to charity social network of registered charities.

24. The website of claim 1 further comprising a trademarked graphic wherein links inherently/intrinsically associated with said graphic can be used to navigate directly to other pages in said website.

25. A computer program running on a computer connected to the internet for the purpose of connecting patrons and charities over the internet comprising:
a module which allows a patron to build a personal portfolio of preferred charities;
a module which allows a charity to build a unique standardized information page which can be publically searched and located through a search engine such as Google;
a module which allows a Charity to be added to a Patron's portfolio page with a single click;
a module which allows a patron to remit simultaneous donations to their personal portfolio charities with a single click.

26. The computer program of claim 25 further comprising a module which allows patrons and charities to interact in an online social network.

27. A method for effecting charitable contributions comprising:
registering a patron on a website;
registering at least two charities on a website and building unique standardized charity pages for each charity by entering information about said charities;
building a portfolio of at least one preferred charity uniquely associated with and accessible by said patron; and
specifying a contribution to a charity in said portfolio; and
simultaneously remitting said contribution with a single click.

28. The method of claim 27 further comprising clearing said contribution.

29. The method of claim 27 further comprising clearing said contribution and taking a transaction fee for transferring said contributions to said charity.

30. The method of claim 27 further comprising clearing said contribution, taking a transaction fee for transferring said contribution to said charity, providing a way to send a patron an invitation electronically to join or attend a charity or event, a way for a patron to make a real time online contribution, give a patron customized directions to events, give a patron customizable transportation and lodging options to attend an event, real time streaming of event live to a charity page, a way to hold an event online, a way to have an auctions on a charity page.

31. A website for connecting patrons and charities comprising:
a function which allows a patron registered with said website to build a portfolio of charities selected from a pool of charities registered with said website; and
a function which allows a charity registered with said website to send simultaneous communications to registered patrons whose portfolios include said charity.

32. A system for connecting patrons and charities comprising:
a database of registered charities comprising profile information about said charities;
a database of registered patrons comprising profile information about said patrons, wherein said registered patrons have agreed to receive solicitations from said registered charities;
a website allowing a registered patron to build a personal portfolio of charities selected from said database of registered charities;
a function associated with said website which allows a registered charity to make a request to the operator of said website to forward a solicitation to registered patrons fitting a certain profile and whose portfolios do not include said charity, wherein said profiled patrons are unknown to said charity when said solicitation is sent out.
